(19) United States
(12) Patent Application Publication
(10) Pub. No.: US 2009/0323697 A1
(43) Pub. Date: Dec. 31, 2009

(54) DATA PAYLOAD TRANSMISSION VIA CONTROL PLANE SIGNALING

(75) Inventors: Ulrico CELENTANO, Oulu (FI); Juha SALOKANNEL, Tampere (FI); Harald KAAJA, Jarvenpaa (FI); Janne MARIN, Espoo (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/163,562

(22) Filed: Jun. 27, 2008

(51) Int. Cl. H04L 12/56

(52) U.S. Cl. 370/395.42; 370/395.2; 370/465

(57) ABSTRACT

A system for implementing a communication transports in a configuration that may utilize control plane resources for the conveyance of data. A communication protocol may be originally designed to support planned data conveyance at a data plane. This strategy may improve quality of service for the transport, but may impact the execution speed of communication due to the required overhead involved in scheduling. In view of this limitation, messages that are sensitive to delay may be negatively impacted by scheduling steps occurring in mediums such as described above. Execution speed may be increased by routing certain payloads to the control plane for transmission in a beacon signal, which avoids the overhead inherent in the data plane.

### BACKGROUND

1. Field of Invention

Various embodiments of the present invention relate to managing the conveyance of wireless information, and more specifically, to the expedited transmission of data by utilizing control-plane resources in a wireless transport.

2. Background

Apparatuses enabled for wired and/or wireless communication may operate using various protocols. A particular medium/protocol selected for communication may be influenced by a multitude of factors. For example, scenarios requiring only small amounts of data to be conveyed would not, taken in view of this requirement alone, be heavily dependent upon carrier speed. However, transmission speed may become more important when the specific transport being implemented is a wireless protocol, and the devices are only expected to pass within transmission range for only a short period of time. It then becomes essential that a wireless link can be established, and the required information can be fully conveyed, in a short period of time.

Similarly, various other factors may also influence transport selection for use in a particular communication situation. These factors may include, for example, whether immediate data transmission is required due to critical or emergency requirements, the amount of data to be conveyed, the conditions of the operating environment (e.g., an area containing a large amount of electromagnetic interference may require a form of communication that is resilient to such interference such as an optical medium), the security requirements for protecting personal and/or confidential information during transmission, the required quality of service (QOS), the abilities/limitations of the apparatuses participating in communication, the applications that will be requiring use of communication resources in an apparatus, networking requirements, etc.

However, “real world” applications are often not as simple as the above example. More specifically, a wired or wireless transport/protocol may be employed in applications where performance requirements may vary. For example, a particular communication transport may be designed to operate well in situations where substantial volumes of data is to be conveyed, and in this capacity, may further include features to schedule and/or reserve communication time so as to avoid potential conflicts. However, there may also be requirements for the communication transport to convey information in instances wherein this mode of operation may not be the optimal utilization of apparatus resources. In particular, an example scenario may include the transmission of remote control signals. These transmissions may be delay-sensitive (e.g., a substantially instantaneous response is expected when a remote control command is issued). Therefore, the overhead involved in establishing a link and reserving a transmission slot in normal operation may not be conducive to uses where the reaction speed should be relatively instantaneous. Moreover, power and processing resources that are wasted when establishing unnecessary formal wireless connections may create a substantial negative impact to, for example, portable apparatuses that rely on the limited energy stored in batteries for operation.

### SUMMARY

Various embodiments of the present invention are directed to the implementation of communication transports in a configuration that may re-task control plane resources for the conveyance of data in order to expedite processing and save resources (e.g., power, energy, etc.) by avoiding formal connection establishment. For instance, typical communication protocols for wireless transports may be designed to support scheduled data transmission over established wireless links. In particular, messages to be sent from an apparatus may be scheduled in accordance with available timeslots. Timeslots may be established through negotiation with other resources also attempting to use the same carrier frequency. This strategy may improve the quality of service for the wireless transport, but may impact the execution speed and increase the amount of resources expended due to the required overhead involved in scheduled operation.

In view of this limitation, messages that are sensitive to delay and apparatuses that are resource-limited may be negatively impacted by scheduling steps occurring in mediums such as described above. For example, wireless transactions involving remote control messages may require fast delivery so that the response to the message may appear relatively instantaneous. In order to support this type of delay-sensitive messaging, it would be beneficial to avoid the formal negotiation that precedes normal data communication. As a result, ad-hoc (e.g., unplanned) or delay-sensitive messaging may proceed more quickly and in a more resource-efficient manner.

In accordance with various embodiments of the present invention, improvements in communication speed, energy conservation, etc. may be realized by avoiding formal message scheduling and connection establishment when transmitting certain messages. For example, a determination may be made as to whether it would be more appropriate to transmit data at an upper level (e.g., a control plane) rather than in accordance with standard operation procedure for a wireless protocol. (e.g., at a data plane). The appropriateness of control plane transmission may depend upon, for example, the amount of data to be transmitted, timing requirements pertaining to the data, established encoding and/or decoding provisions, etc. If data is deemed appropriate for transmission at the control plane, this data may be included in the payload of a control plane signal (e.g., a beacon signal). For example, the data to be transmitted may be included in the payload of a beacon packet, or alternatively, may sent in more than one payload packet if any delay experienced by sending the data in this fashion will not impact overall quality of service.

The various example embodiments of the present invention will be illustrated hereinafter in the description of example embodiments of the invention as well as in the claims appended hereto. The embodiments are illustrated with reference to selected example aspects of the invention. A person skilled in the art appreciates that any embodiment of the invention may apply to other aspects as well either alone or in combination with other embodiments and that the present application is not be limited to any particular embodiment.

### DESCRIPTION OF DRAWINGS

The invention will be further understood from the following detailed description of various example embodiments, taken in conjunction with appended drawings, in which:

FIG. 1A discloses an example of a computer and communication system with which various embodiments of the present invention may be implemented.

FIG. 1B discloses an example of multiple apparatuses interacting using WiMedia 1.0 (ECMA-368, ISO/IEC-26907, hereafter referred to as WiMedia) in accordance with at least one embodiment of the present invention.

FIG. 2A discloses an example of WiMedia operation in accordance with at least one embodiment of the present invention.

FIG. 2B discloses an example of a WiMedia message packet in accordance with at least one embodiment of the present invention.

FIG. 2C discloses an example of a WiMedia message packet wherein a new information element (IE) provides means to transfer payload data within a beacon period, in accordance with at least one embodiment of the present invention.

FIG. 3A discloses additional detail regarding an example of WiMedia operation in accordance with at least one embodiment of the present invention.

FIG. 3B discloses additional detail regarding an example of WiMedia operation in accordance with at least one embodiment of the present invention.

FIG. 4 discloses an example of a wireless transaction wherein data may be sent from the data plane of a communication protocol in accordance with at least one embodiment of the present invention.

FIG. 5 discloses an example of a wireless transaction wherein data may be sent from the control plane of a communication protocol in accordance with at least one embodiment of the present invention.

FIG. 6A-6B, 7A-7B, 8, 9A-9B, 10A-10B, 11A-11D, 12A-12D, 13A-13B, 14A-14D, 15 and 16 disclose examples of communication packet structures usable for transmitting data from the control plane in accordance with at least one embodiment of the present invention.

FIG. 17 discloses an example of a beacon packet with a data payload that may be sent from the control plane of a communication protocol in accordance with at least one embodiment of the present invention.

FIG. 18 discloses an example of a process for transmitting data from a control plane of a wireless transport in accordance with at least one embodiment of the present invention.

### DESCRIPTION OF EXAMPLE EMBODIMENTS

While the present invention has been described herein in terms of a multitude of example embodiments, various changes or alterations can be made therein without departing from the spirit and scope of the present invention, as set forth in the appended claims.

### I. General System With Which Embodiments of the Present Invention may be Implemented

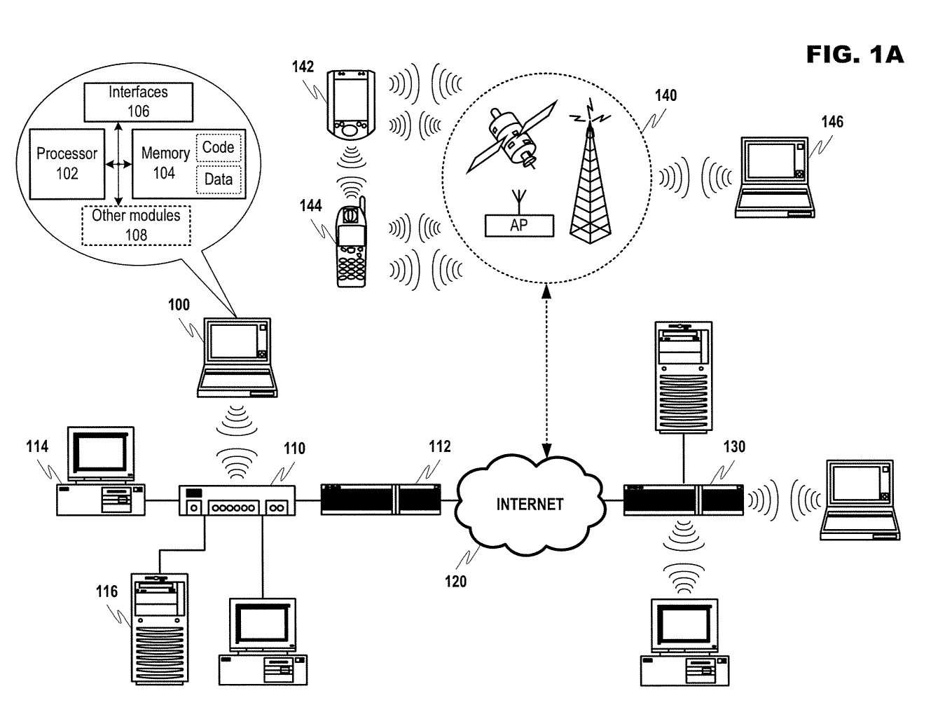

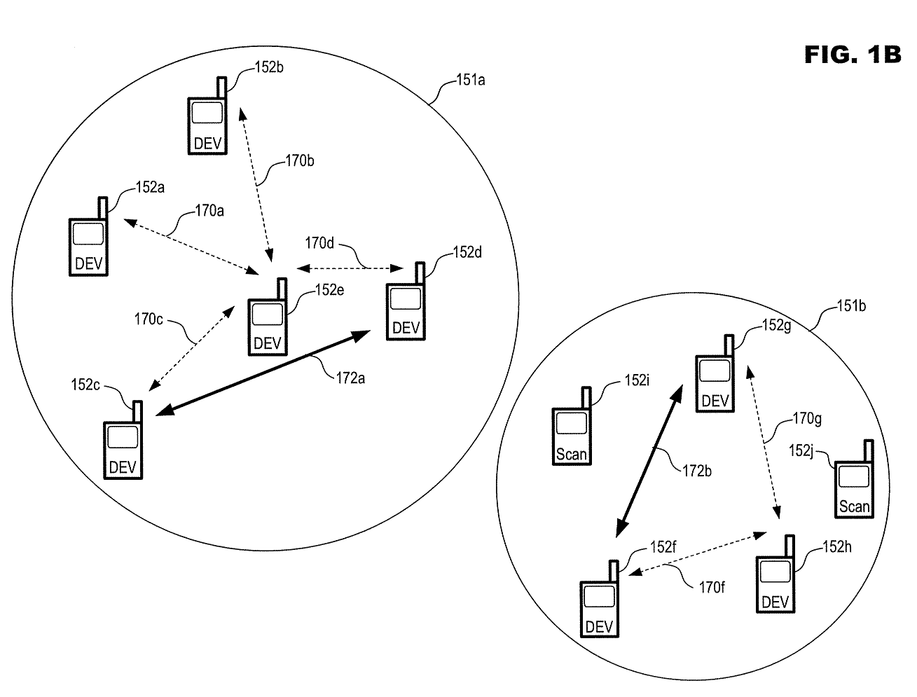

An example of a system comprising multiple apparatuses linkable in wired and/or wireless network configurations usable in accordance with various embodiments of the present invention is disclosed in FIG. 1. The example system shown in FIG. 1 may include elements incorporated in, or omitted from, a configuration depending, for example, on the requirements of a particular application, and therefore, is not intended to limit present invention in any manner. For instance, the example networked apparatuses disclosed in FIG. 1 may be applied to various applications, such as the conveyance of commands and sensor data such as, for example, GPS module and cell-phone/PDA, heart rate (HR) and other bodily sensors, and wrist computers, as well as various kinds of infra-red remote controls like for appliances, cameras, music, etc.

Computing device 100 may be, for example, a laptop computer, PDA, cellular telephone, pager, or network hub. Examples of various components that may comprise functional elements in computing device 100 are disclosed at 102-108. Processor 102 may include one or more devices configured to execute instructions, wherein a group of instructions may be constituted, for example, as program code. In at least one scenario, the execution of program code may include receiving input information from other elements in computing device 100 in order to formulate an output (e.g., data, event, activity, etc). Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 100 may provide wired and/or wireless support to devices such as computer 114 and server 116. Hub 100 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this configuration example are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

### II. Communication Configuration Examples

Before describing some examples of the various embodiments of the present invention in detail, it is first helpful to describe an environment in which at least some of the example embodiments of the present invention may be employed. Accordingly, FIG. 1B is a diagram of an example operational environment in which the principles of the present invention may be employed. This environment includes multiple beaconing groups 151, each having a plurality of devices 152. For instance, FIG. 1B shows a beaconing group 151a, which includes member devices (DEVs) 152a-e. FIG. 1B also shows a beaconing group 151b, which includes DEVs 152f, 152g, and 152h.

In beaconing group 151a, each of DEVs 152a-d may communicate with DEV 152e across a corresponding link 170. For instance, FIG. 1B shows DEV 152a communicating with DEV 152e across a link 170a. In addition, in beaconing group 151a, each of devices 152a-e may communicate with each other directly. For instance, FIG. 1B shows DEVs 152c and 152d communicating via a direct link 172a. In beaconing group 151b, each of DEVs 152f and 152g may communicate with DEV 152h across a corresponding link 170. For instance, DEV 152f communicates with DEV 152h across a link 170f, while DEV 152g communicates with DEV 152h across a link 170g. DEVs 152f and 152g in beaconing group 151b may also communicate with each other. For example, FIG. 1B shows DEVs 152f and 152g communicating across a link 172b. Each of links 172 and 170 may employ various frequency hopping patterns. These patterns may include, for example, one or more Time Frequency Codes (TFCs). In embodiments of the present invention, each beaconing group 151 employs a particular frequency hopping pattern. These patterns may either be the same or different.

In addition, FIG. 1B also shows devices 152i and 152j, which do not belong to either of the beacon groups. Instead, both devices 152i and 152j may be willing to join to beacon group 151b simultaneously. For example, if these devices, when joining beacon group 151b transmit their beacon transmissions during the same beacon slot, a collision may occur. This may lead to unnecessary delays for the devices 152i and 152j to join the beacon group 151b. The present invention provides improvements to network joining operations in such events.

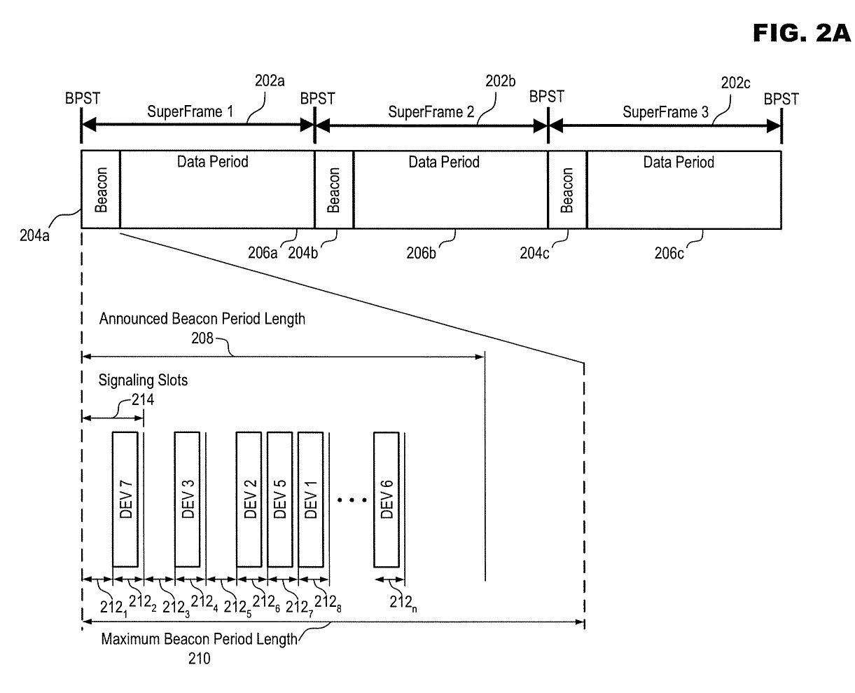

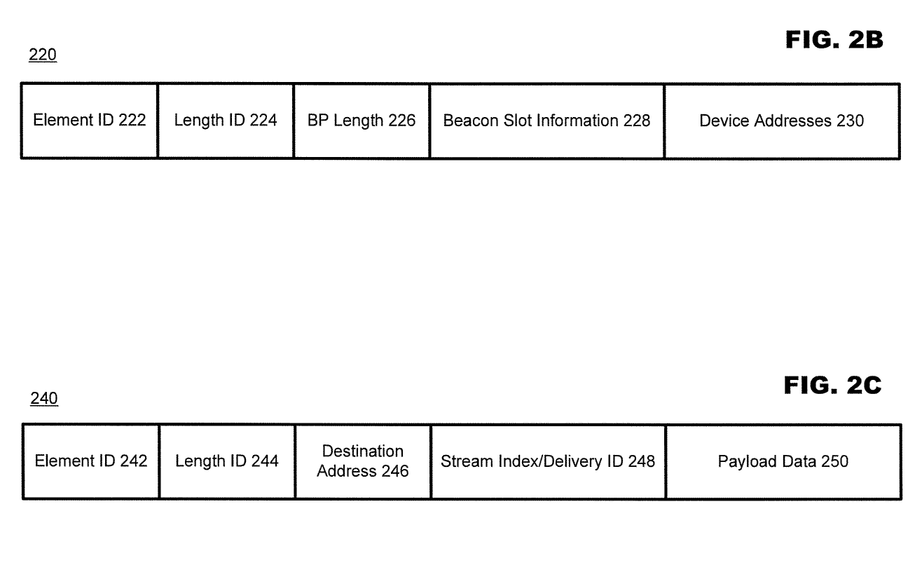

Transmissions of beaconing groups 151a and 151b are each based on a repeating pattern called a superframe. Accordingly, FIG. 2A is a diagram showing an example WiMedia MAC superframe format. In particular, FIG. 2A shows a frame format having superframes 202a, 202b, and 202c. As shown in FIG. 2A, superframe 202b immediately follows superframe 202a, and superframe 202c immediately follows superframe 202b. Each superframe 202 includes a beacon period 204 and a data period 206. Beacon periods 204 convey transmissions from each of the active devices in the beaconing group. As shown in FIG. 2A, beacon period 204a has an announced length 208, which is less than or equal to a maximum beacon period length 210 (also referred to as mMaxBPLength 210).

Multiple beacon slots 212 exist during beacon period. During these slots, devices may transmit their respective beacons. Accordingly, each of these slots may correspond to a particular device in the beaconing group. For instance, FIG. 2A shows device 7 transmitting in slot 212₂, a device 3 in slot 212₄, a device 2 in slot 212₆, a device 5 in slot 212₇, a device 8 in slot 212₈, and a device 6 in slot 212ₙ. The first two beacon slots (i.e., slots 212₁ and 212₂) are referred to as signaling slots. These slots are usually left unused and they are used, for example, to indicate changes in beacon period length. Accordingly, in certain situations, devices occupying the highest beacon slots may repeat their beacon transmissions in these slots. This repetition of beacon transmissions is performed in the same beacon period or in the same superframe.

Beacons may contain various overhead or networking information. For instance, beacons may contain information regarding resource allocations and beaconing group configuration. Such information may be in the form of various information elements (IEs). One such IE is the beacon period occupancy IE (BPOIE). Devices transmit BPOIEs in their beacons to provide information regarding the beacon period that they observe. FIG. 2B is diagram of an example of a BPOIE packet 220, according to at least one embodiment of the present invention. As shown in FIG. 2B, BPOIE 220 may include various fields. The fields contained in BPOIE packet 220 may include, for example, an element ID field 222, a length field 224, a BP length field 226, a beacon slot information field 228, and device address fields 230.

Element ID field 222 may identify this information element as a “BPOIE” 220 for a receiving device. Length field 224 may indicate the length of BPOIE 220. BP length field 226 may convey the length of the beacon period in the number of beacon slots from the transmitting device's perspective. Beacon slot information field 228 may consist of multiple 2-bit elements to indicate the beacon slot occupancy and movability within beacon period. Device address fields 230 may correspond to beacon slots that are encoded as occupied by field 228. In particular, these fields may provide device addresses for each of the occupied beacon slots.

Referring again to FIG. 2A, data periods 206 may be used for devices to communicate data according to, for example, frequency hopping techniques that employ OFDM and/or TFCs. For instance, data periods 206 may support data communications across links 120 and 122. The term “data” is defined here to include the existing “data pipe” between devices having the specified stream index, for example, as related to a stream in the WiMedia specification. In the WiMedia MAC 1.2, a stream is a logical flow of MAC service data units (MSDUs) from one device to one or more other devices. A MAC service data unit (MSDU) is information that is delivered as a unit between medium access control service access points (SAPs). In addition, devices (e.g., DEVs 152a-e) may use data periods 206 to transmit control information, such as request messages to other devices. To facilitate the transmission of traffic, each DEV may be assigned a particular time slot within each data period 206. In the context of the WiMedia MAC specification, these time slots are referred to as medium access slots (MASs).

A MAS is a period of time within a data period 206 in which two or more devices are protected from contention access by devices acknowledging the reservation. MASs may be allocated by a distributed protocol, such as the distributed reservation protocol (DRP). Alternatively, resources may be allocated by the prioritized contention access (PCA) protocol. Unlike DRP, PCA isn't constrained to reserving one or more entire MASs. Instead, PCA can be used to allocate any part of the superframe that is not reserved for beaconing or DRP reservations, or also reserved DRP slots that are left unused and thus released.

FIG. 2C discloses an example of a WiMedia message packet wherein a new information element (IE) provides means to transfer payload data within a beacon period, in accordance with at least one embodiment of the present invention. As shown in FIG. 2C, the IE packet 240 may include various fields. The fields contained in E packet 240 may include, for example, an element ID field 242, a length field 244, a destination address field 246, a stream index/delivery ID field 248, and payload data field 250 that contains the actual data to be transmitted within the within the control plane.

Element ID field 242 may identify this information element as a “data IE” 240 for a receiving device. Length field 244 may indicate the length of the data IE 240. Destination address field 246 may convey the destination address of the intended receiver. The destination address may contain one or more device addresses and even a multicast or broadcast group address. The stream index/delivery ID field 248 links the payload data in the payload data field 250 in beacon transmissions with an existing data stream. In the WiMedia MAC 1.2, a data stream is a logical flow of MAC service data units (MSDUs) from one device to one or more other devices. A MAC service data unit (MSDU) is information that is delivered as a unit between medium access control service access points (SAPs).

The data IE packet 240 enables transmitting of small amounts of payload data in beacon transmissions within WiMedia networks so that the payload data is linked with specific destination address and stream index. A substantially small payload data can be embedded as it is, or alternatively coded, into proper information elements 240 and then placed in the beacon frame. In this way, small payload data packets may be transmitted within WiMedia UWB networks with large overhead reduction.

The term “data” is defined herein to include the existing “data pipe” between devices having the specified stream index, for example, as related to a stream in the WiMedia specification. In the WiMedia MAC 1.2, a stream is a logical flow of MAC service data units (MSDUs) from one device to one or more other devices. A MAC service data unit (MSDU) is information that is delivered as a unit between medium access control service access points (SAPs).

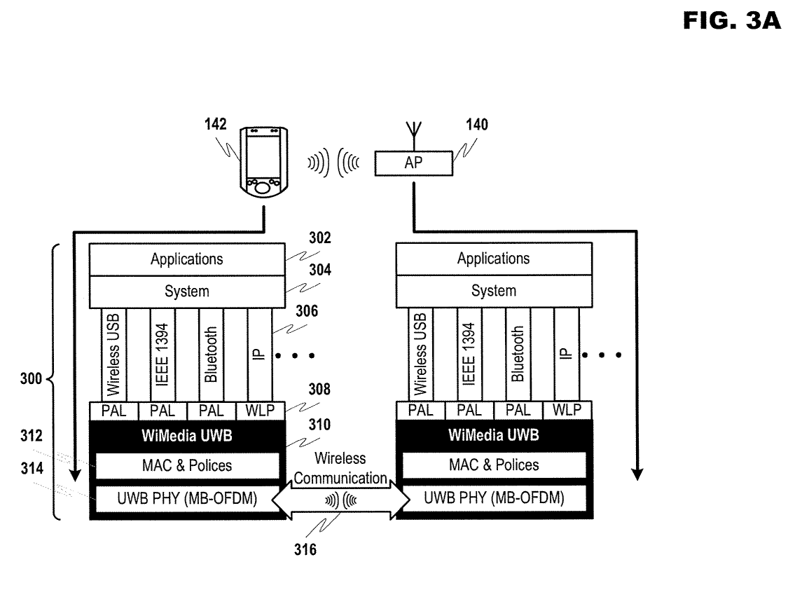

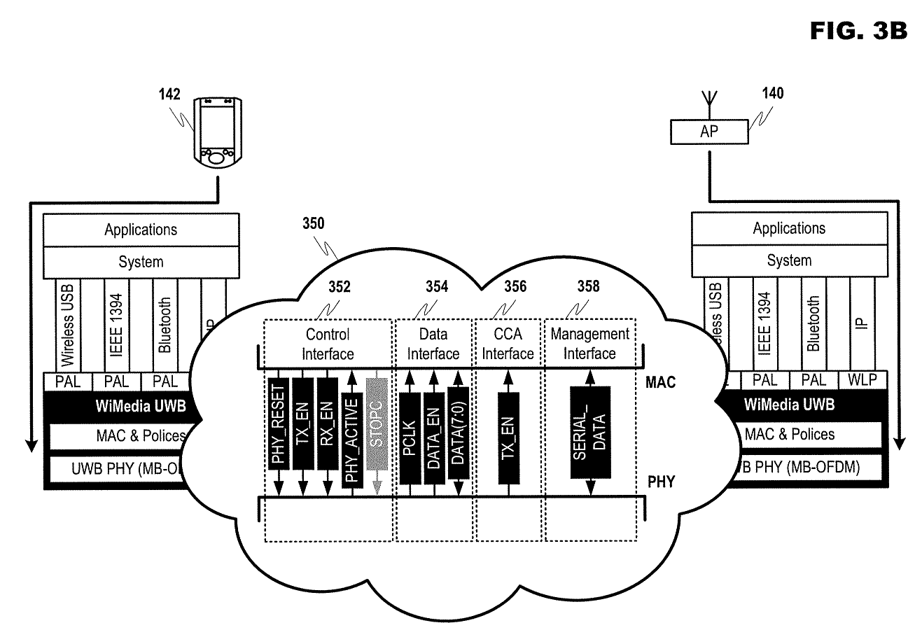

FIG. 3A discloses an implementation example that will be utilized to explain the various example embodiments of the present invention. While the WiMedia wireless protocol will be discussed in the following disclosure, use of this protocol is in no way intended to limit the application or implementation of the aforementioned example embodiments. The present invention may be implemented with any similar wireless medium, existing now or in the future.

FIG. 3A discloses an example of two apparatuses communicating via a wireless medium 316. Each device may include a protocol stack 300 including WiMedia standard-based components usable with various embodiments of the present invention. As previously set forth, while apparatus 142 and access point 140 have been shown in this example for the sake of explanation, the present invention is not limited to the disclosed scenario, and may therefore be implemented with any or all of the example devices shown in FIG. 1. Protocol stack 300 may initially comprise applications layer 302. At least one program module in applications layer 302 may need to transmit and/or receive data through the communication resources provided in the disclosed devices. To gain access to communication resources in apparatus, programs in applications layer 302 may interact with in system level 304. This level of protocol stack 300 may include operating system components and or resources to process and/or route data provided by at least one program in applications layer 302 for use by lower level transmission resources.

Protocol level 306 discloses a plurality of wireless communication transports that may utilize the standardized Media Access Control (MAC) layer 312 and physical PHY layer 314 provided by WiMedia layer 310. Examples of protocols that are usable with WiMedia 310 may include, but are not limited to wireless Universal Serial Bus (wireless USB), wireless IEEE 1394 (wireless Firewire), Bluetooth™, and TCP-IP. Each of these wireless protocols may interact with WiMedia layer 310 via protocol adaptation layer (PAL) 308. In the case of TCP-IP, the interface component residing in PAL layer 308 may also be called WiMedia logical link control protocol(WLP). WiMedia layer 310, comprising MAC layer 312 and PHY layer 314 (e.g., configured to operated in UWB using MB-OFDM) may receive usage requests from one or more of the above protocols. WiMedia layer 310 may manage these requests by granting access to each active protocol in protocol layer 306 in a manner that prevents concurrently operating protocols from interfering with each other.

FIG. 3B discloses additional detail regarding the operation of WiMedia layer 310 in accordance with at least one embodiment of the present invention. Examples of messages that may occur at various levels, or interfaces, are shown at 350. Control plane messages are represented at 352. These messages may include commands that both monitor and control the physical layer of the apparatus. Data interface level 354 comprises commands that are used to indicate to protocol level 306 (via PAL level 308) when they may send data, or alternatively, when there is incoming data from the PHY layer.

### III. Examples of Enhanced Message Transmission.

The present invention, in accordance with at least one embodiment, may allow for the sending of up to about 3 kbits uncompressed additional data per superframe (SF), wherein an example SF may have a period of about 65 ms, or may equivalently sustain a rate of up to 50 kbit/s of uncompressed data over WiMedia 1.0 (ECMA-368, ISO/IEC-26907, hereafter referred to as WiMedia). This data rate enhancement may provide adequate support for delay-sensitive applications like remote control signals. In addition, some strategies proposed herein may allow for even faster rates of compressed information to be transmitted in a lossless manner. For example, the compression rate may be larger when coded patterns repeat more often. Further, through transmission of data utilizing the payload of control-level signals designed for providing distributed network control, an improvement in overall network efficiency may be realized as the participating apparatuses don't have to reserve portions of the data period for sending small packets, and further, other devices can then utilize the available data period.

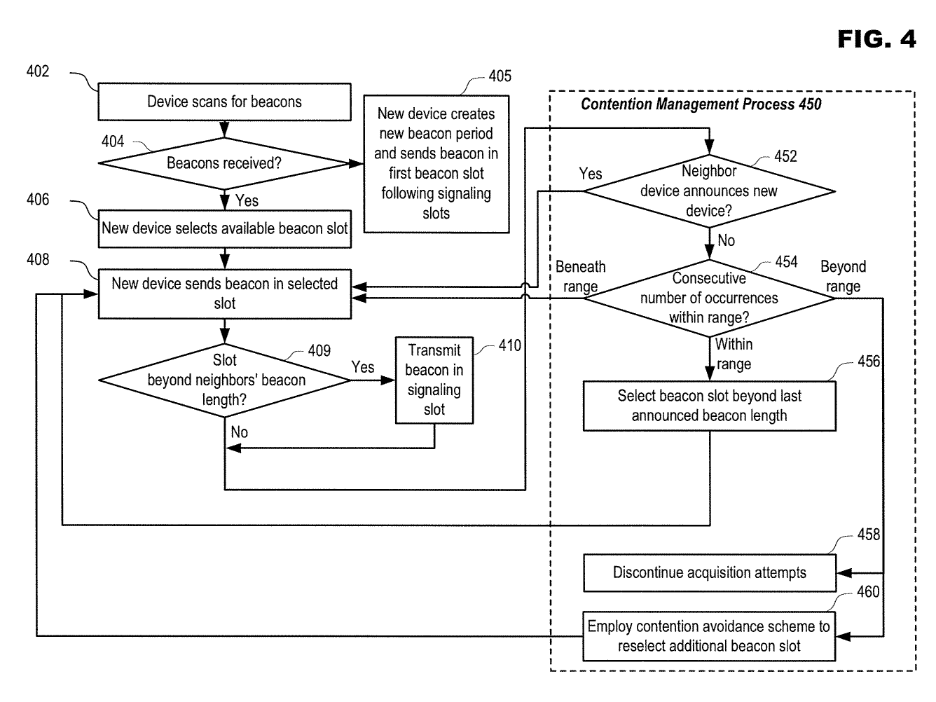

Data is typically sent using data plane resources in a communication protocol. An example of message transmission for wireless data protocols that may be utilized to implement various embodiments of the present invention is shown in FIG. 4. FIG. 4 discloses an example flowchart of an operational sequence involving the acquisition of a beacon slot by a device. As shown in FIG. 4, this sequence may include step 402, in which the device scans for beacons over a predetermined number (e.g., one or more) superframes. As indicated by step 404, operation may proceed to step 405 if the device receives no beacon frames in step 402. Otherwise operation may proceed to step 406 in which the device may select a beacon slot. This selected slot may be any beacon slot after the highest numbered unavailable beacon slot the device observed in step 402 and within the maximum beacon period length announced by any of the neighboring devices in the beaconing group. Accordingly, in a step 408, the device may transmit a beacon in the slot selected in step 406. As indicated in step 409, if the selected beacon slot is located beyond the beacon period length of any of the device's neighbors, then step 410 may be performed. In this step the device may transmit the beacon (except for a beacon slot number field) in a signaling beacon slot that it randomly chooses.

The apparatus may determine whether a collision occurred in the transmission of its beacon. If so, the device may randomly choose a different beacon slot for its subsequent beacon transmissions. This different beacon slot may be located after the highest numbered unavailable beacon slot observed in step 402 and the operation may return to step 408 for the continued transmission of beacons.

In the operational sequence of FIG. 4, the device may change its selected beacon slot if a collision occurs. However, a device may not always be able to detect such a collision. This inability may be attributed to various reasons, such as device coverage areas that do not completely overlap. Consistent with the above technique, FIG. 4 further discloses a flowchart of an operational sequence of a device involving the acquisition of a beacon slot. Contention management process 450 may include step 452. In this step the device may determine whether any neighboring devices have announced the presence of the device. Such announcements may be in the form of BPOIEs indicating the device's use of a particular beacon slot.

If such an announcement has been made, the operation may proceed to step 408 in which the device may continue to transmit beacons in its previously selected beacon slot. However, if such an announcement has not been made, the device may select a different beacon slot or discontinue its attempts to acquire a beacon slot. Such determinations may be based on various factors. For instance, in embodiments, the device determines the consecutive number of times (i.e., the consecutive number of superframes) that it has not received an announcement of its presence. Accordingly, as indicated by a step 454, the device may determine the consecutive number of times that it has failed to receive such an announcement. If the consecutive number of times fall short of a predetermined range, then operation may return to step 408 wherein the device continues to transmit beacons in its previously selected beacon slot, or may select a free beacon slot after the previously selected beacon slot within last announced beacon period length in situations where the previously selected beacon is reserved.

Alternatively, if this consecutive number of times is within a predetermined range, then the device may assume that a collision has occurred and operation may proceed to step 456. In step 456, the device may select a new beacon slot that is beyond the last announced beacon period length. As described above, such lengths may be announced in neighboring devices' BPOIEs. Step 408 follows step 456 in which the device transmits its beacon during the newly selected beacon slot. In this case, the device may also (according to step 410) transmit its beacon in a signaling slot because the slot chosen in step 456 was beyond the last announced beacon length. As described previously in connection with FIG. 2B, the BPOIE may include beacon slot information. This information indicates to other devices that the beacon period length has been extended as the new beacon slot is beyond the last announced beacon period length. Further, as indicated previously, even in situations where there is a collision between beacon transmissions in signaling slots, any device that detects a beacon transmission attempt in signaling slots shall listen for a maximum time (e.g., also referred to as mBPErrorExtension).

As described above, the device may stop trying to acquire a beacon slot. For instance, the device may execute step 458 if it determines in step 454 that the consecutive number of times an announcement of its presence has not been received is greater than the predetermined range. Accordingly, in step 458, the device may discontinue its attempts to acquire a beacon slot. Moreover, in this step, the device may communicate to its upper protocol layers that communications are not currently possible. As an alternative to step 458, step 460 may be performed. In this step, the device may apply a collision detection scheme and try to select another slot from the available slots. If successful, then operation proceeds to step 408.

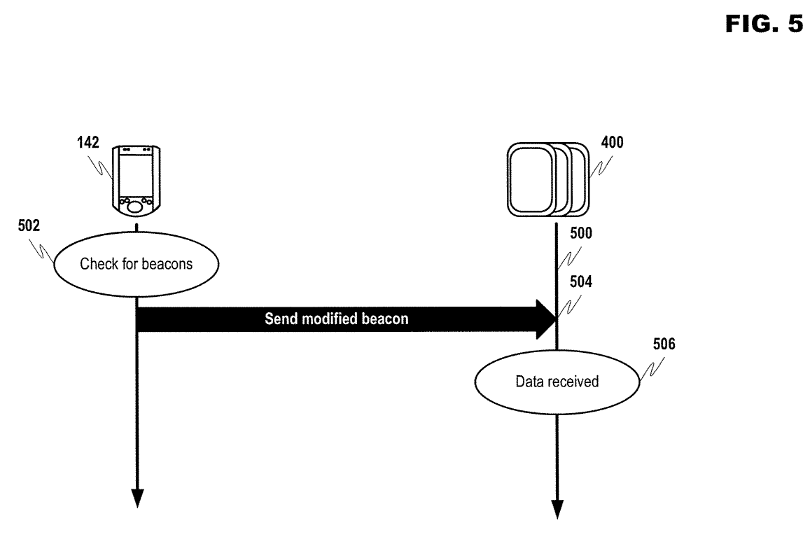

In order to establish data communication in a data period, participating apparatuses need to negotiate through their respective beacons, which are the “essential” control means of WiMedia networks. Being an essential part of WiMedia communication protocol, beacons are always transmitted by active (non hibernating) devices. However, under certain conditions it may be possible to convey data more efficiently over unused portions of the control plane. An example control plane data communication in accordance with at least one embodiment of the present invention is disclosed in FIG. 5. Following flow arrow 500, apparatus 142 may initially check for beacons at 502. In order for devices to participate in a WiMedia beacon group (e.g., a WiMedia network), devices need to both transmit and listen for transmit beacons. So in order for a device to send a modified beacon signal to other devices, it first needs to have received a beacon from the other device indicating that the other device is a member of the beacon group, and it must also inform the other device of its participation in the beacon group. Once gained a beacon slot, no further contention is needed to keep it. In configuration shown in FIG. 5, a modified beacon signal may be sent at 504. The “modified” beacon signal includes the IE described in FIG. 2C, including the payload. The beacon signal may include payload information that would ordinarily be sent at the data plane of the communication protocol, the data being received by other apparatuses 400 at 506.

For delay-sensitive services, a maximum sustainable rate may be identified below which it may be possible to move data transmission from data plane (e.g., the data period, or DP, in the WiMedia MAC 312) to control plane (BP). However, only a limited amount of data may be conveyed in the BP within a time unit (e.g., a superframe, SF, in WiMedia MAC 312), which means that a large amount of data would need more than one SF to be completely transferred. As a result, large amounts of data may also be conveyed at the control plane, but possibly only in case of delay-tolerant communication. In at least one embodiment of the present invention, MAC 212 may also have some knowledge of the data type and/or data traffic characteristics (rate, buffered traffic, etc.), and therefore, may be able to determine the more appropriate transmission method. This may be the preferred method if data can be transmitted in control plane (e.g., in accordance with message timing requirements). If not, data may be conveyed at the data plane (e.g., during the data period, DP). Acknowledgement messages may also be conveyed at the control plane.

Various embodiments of the present invention may incorporate at least two main ideas: (1) transmission of data in beacons in dedicated information elements (IE). In this way, timeslots otherwise used in DP MAS may be “reassigned” to DATA-IE; and (2) The use of abbreviated messages or “compression” to represent a set of information such as device addresses, stream index, and possibly encoded payloads that may be “virtually” exchanged between a source and destination. As a result, some of the communication activities that would ordinarily be scheduled to occur during the DP may be avoided, which may allow the BP activity duty cycle to be consolidated to only one period. Reducing the amount of data that needs to be sent from the data plane may lessen the negative impact on speed caused by link establishment. Further, if all data transmission can be executed from the control plane, then the radio may only have to be ramped up and down once per superframe, allowing for significant energy savings. An additional benefit that may be realized through the sending of encoded payloads is that any third-party device that managed to receive or even “intercept” (e.g., in the instance of a “man-in-the-middle” attack where the goal is to steal data) the transmission would probably not have the encoding and/or decoding information necessary to translate the compressed message back into its normal form, and therefore, an additional layer of security is added by using virtual payloads.

Once a communication link is established (e.g., DATA-IE messages established for use in the transmission of actual data payloads, or the completion of preparation for virtual payload transmission), various embodiments of the present invention may allow expedited data transmission without the overhead involved in the acquisition of channel time (e.g., DP MAS in WiMedia). As a result, an enabled device may promptly send information. These example embodiments may also be deemed robust in that a legacy device not implementing an example embodiment of the present invention may ignore and discard unspecified information elements or information elements otherwise not recognizable as a part of standard protocol operation.

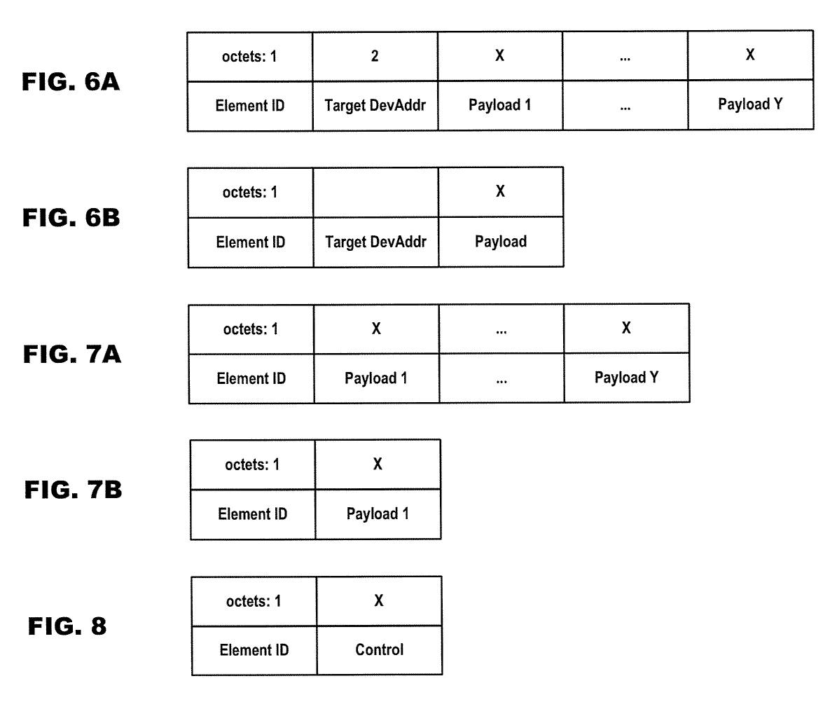

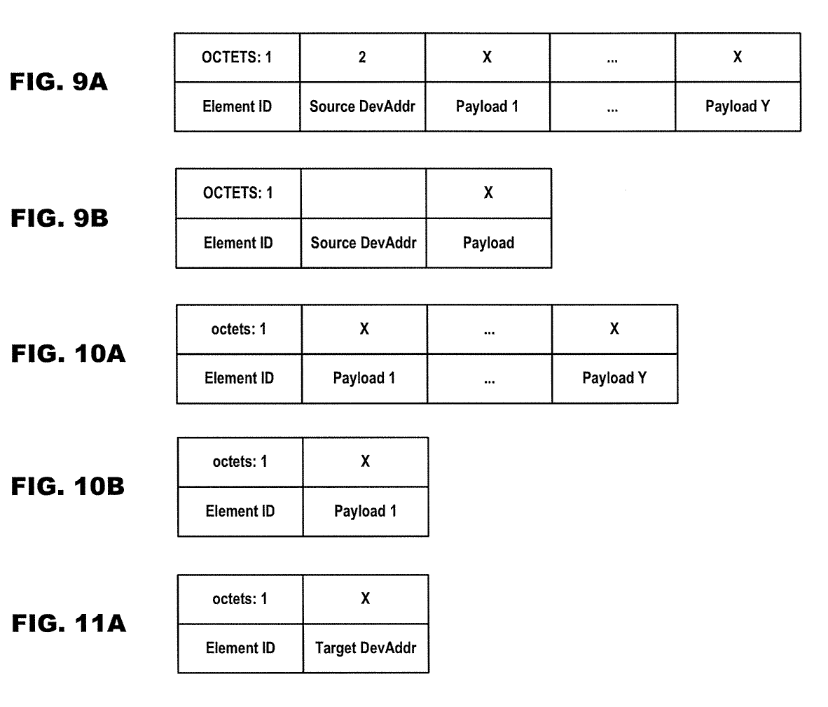

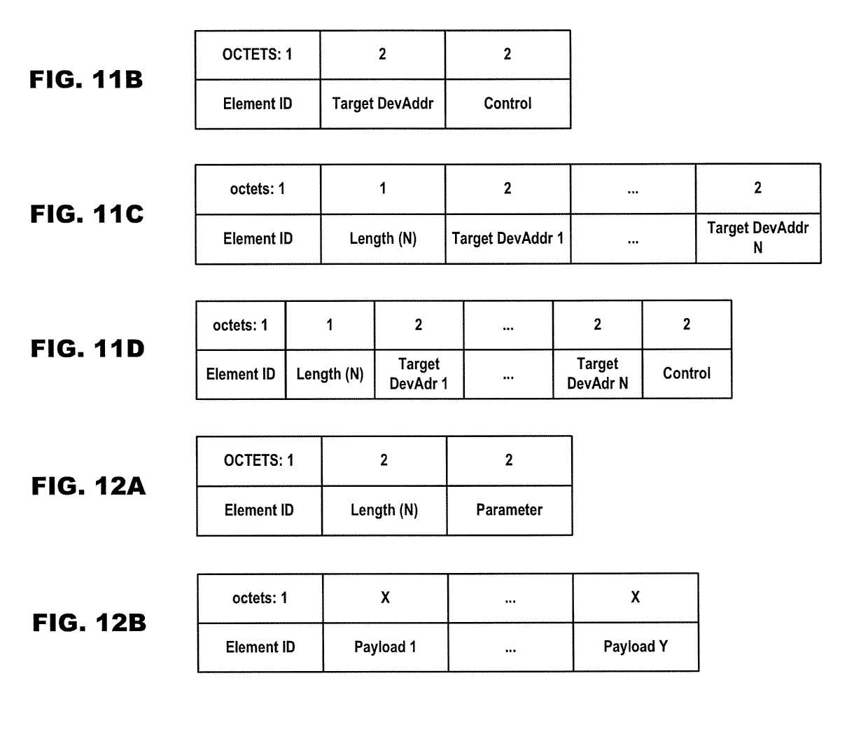

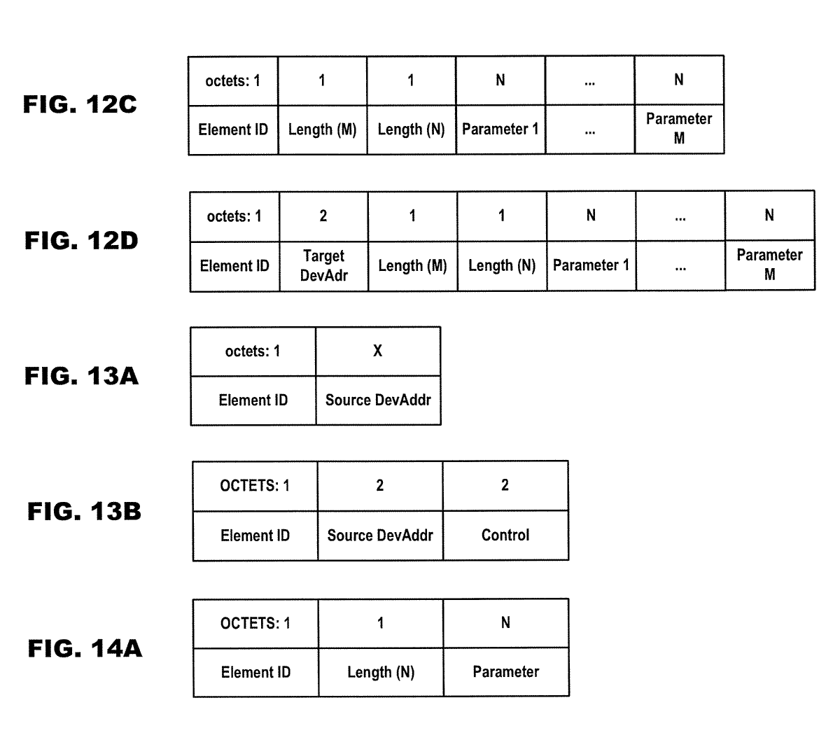

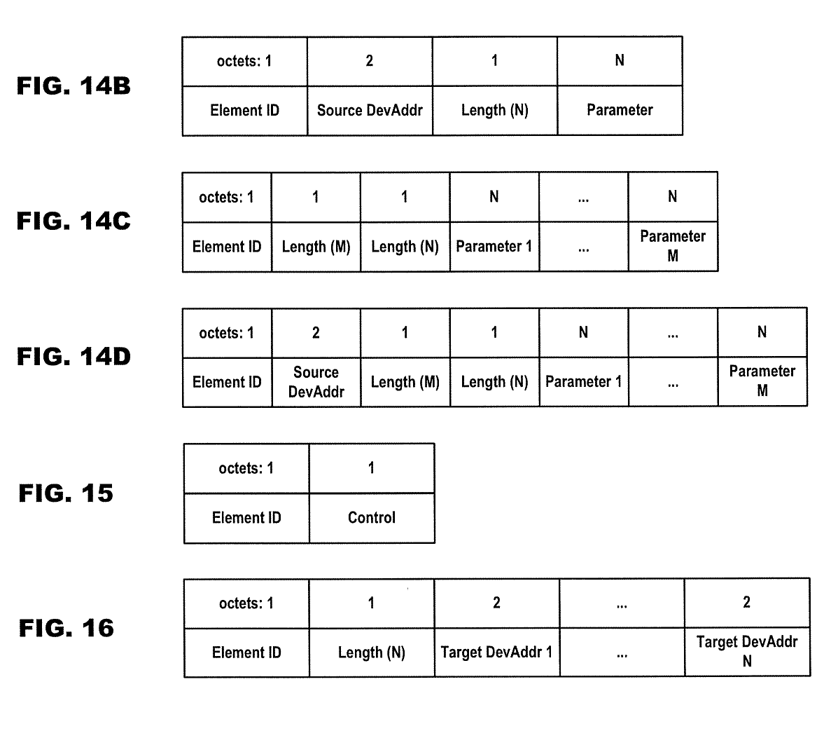

Data transmission from the control plane may occur in two forms: Actual payload transmission and virtual payload transmission. These data transmission methods may utilize the DATA-IE packet formats, as defined in FIG. 6A-16 for data transmission. Further, DATA-IE information for more than one connections/stream may be present in the same beacon frame. Both DATA-IE with actual data (alternatively named ADATA-IE) and DATA-IE with virtual data (alternatively named VDATA-IE) may be present in the same beacon frame.

FIGS. 6A and 6B disclose example packet structures for a virtual data information element utilizing explicit addressing (VDATA/E-IE). This information element may be used for transmitting short-data with explicit addressing. The number of components in the information element and their sizes may depend on the specific application and implementation. These components may be well-known (e.g., hard-coded), or specified during set-up. The content of the first field is the destination address. The following fields may include the short-data payload. FIG. 6A discloses a more generic format, whereas FIG. 6B discloses an example short form for VDATA-IE packets. Content of VDATA-IE packets may be a compressed version of fields corresponding to the protocol specification.

FIGS. 7A and 7B discloses example packet structures a virtual data information element utilizing implicit addressing (VDATA/I-IE). This information element may be used for transmitting short-data with implicit addressing. The number of components of the information element and their sizes may depend on the specific application and implementation. These components may be well-known (e.g., hard-coded), or specified at set-up. The fields include the short-data payload. FIG. 7A discloses a more generic format, whereas FIG. 7B discloses an example short form of a VDATA-IE.

FIG. 8 discloses an example packet structure for a virtual data information element for short acknowledgement utilizing implicit addressing (VACK/S-IE). This information element may be used for short acknowledgement. The entire received short-control data payload IE may be acknowledged by properly setting the “Control” field.

FIGS. 9A and 9B disclose example packet structures a virtual data information element for long acknowledgement utilizing implicit addressing (VACK/LE-IE). This information element may be used for long acknowledgement in explicit addressing. The individual fields received as part of the VDATA IE packet may be acknowledged by simply replicating their contents by properly switching the DevAddr field content. FIG. 9A discloses a more generic form, while FIG. 9B discloses an example short form of VACK/LE-IE.

FIGS. 10A and 10B disclose example packet structures for a virtual data information element for long acknowledgement utilizing implicit addressing (VACK/LI-IE). This information element may be used for long acknowledgement in implicit addressing. The single received fields of the VDATA IE may be acknowledged by simply replicating their contents. FIG. 10A discloses a more generic form, while FIG. 10B discloses an example short form of VACK/LI-IE.

FIG. 11A-11D disclose example packet structures for a virtual set-up information element (VSETS-IE). This information element may be used for initial configuration. Possible implementations may include, but are not limited to: FIG. 11A wherein the address of the destination device, referred to also as target device, interchangeably, is included; FIG. 11B, which is similar to FIG. 11A, but may also incorporate a control field including, for example, some or all of the information specified for frame control in the protocol specification. This information may be used implicitly in FIG. 11C where two or more destinations/targets may be specified. In this example, a length field may also be required; and FIG. 11D which is similar to FIG. 11C but may also include a frame control field in the same manner as set forth in the example shown in FIG. 11B.

FIG. 12A-12D disclose example packet structures for a virtual set-up parameter information element (VSETPD-IE). This information element may be used for parameter establishment. In particular, the packet structure disclosed in FIG. 12D may include a vector of parameters that were sent in the IE. If not defined in a previous step, these parameters may include control information such as ACK type, stream index, etc. These parameters may also include the length X and Y used for VDATA IEs. For example, if a payload is transmitted in a virtual mode (e.g., using compressed data corresponding to the actual data), a look-up-table may be included at the destination side for interpreting the virtual payload. This may be achieved, for example, by sending a pair of VSETP IE messages, one with the code (or vector of codes or portion of the vector of codes) and the other with the corresponding actual payload (or vector of payloads or portion of the vector of payloads).

FIGS. 13A and 13B disclose example packet structures for a virtual set-up long acknowledgement information element (VSACK-IE). This information element may be used for long acknowledgement of initial configuration. The content of the received fields may be replicated from the configuration data. FIG. 13A discloses a more generic form, while FIG. 13B discloses an example short form of VSACK/LE-IE.

FIG. 14A-14D disclose example packet structures for a virtual set-up parameter long acknowledgement information element (VACKPD-IE). This information element may be used for long acknowledgement of parameter establishment. The content of the received fields may be replicated from the configuration data disclosed in FIG. 12A-12D

FIG. 15 discloses an example packet structure for a virtual long acknowledgement of parameterized link configuration information element (VPACK-IE). This information element may be used for long acknowledgement of parameterized link configuration. The content of the received fields may be replicated from the configuration data.

FIG. 16 discloses an example packet structure for virtual set-up short acknowledgement of link establishment information element (VACK-IE). This Information element may be used for short acknowledgement of link establishment. The content of the received fields may be replicated from the configuration data.

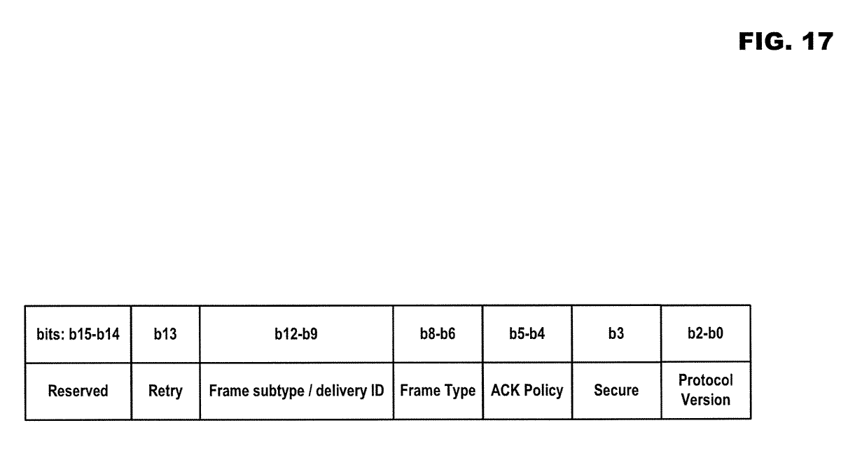

FIG. 17 discloses an example of a frame control field from a DATA-IE (ADATA-IE) usable with actual transmission of payload methods. The same IE packet may also be used for ACK with Actual transmission of payload methods. The content may be compliant with standard specifications (e.g., WiMedia), wherein only the carrier may change.

Operation may initiate in the same manner as legacy devices. However, prior to transmission “data carriers” (“slots”) may be removed from DP and the same data pipe (same DstAddr and stream index) and transferred to the newly defined DATA-IE. Both DATA-IE and DRP-IE may appear in beacons corresponding to each superframe. Both source and destination devices may include the new IEs (e.g., as defined above) in their beacon signal. Using this method, DRP negotiation may be explicit or implicit. In addition, everything related to data exchange, DRP negotiation and the actual data transmission may be completed in the BP. In particular, no MAS are reserved in the DP as the data is directly sent through DATA-IE. With this method, implicit DRP negotiation may be more appropriate, since DP is not being used.

The length of DRP-IE may be six octet bytes long even with no MAS allocation. Communication of small data may be done more effectively with lower overhead in beacons. Some redundant control information commonly included with DRP-IE may be removed when transmitting data from the control plane. In particular, the need for DRP-IE is reduced. For example, DRP-IE may be utilized during set-up and tear-down only, and therefore, may be skipped in subsequent beacons.

The DRP-IE may be removed from the beacons at end of DRP negotiation. For example, with implicit DRP reservation protocol the owner device (e.g., the source device) adds a DRP-IE with Owner bit set to ONE. Then, the target device (e.g., the destination device), may respond with its DRP-IE with Owner bit set to “0.” When Reservation Status is set to “1,” the reservation is granted. At this time, the DRP-IE may be removed from the beacon frame. The DRP-IE may again be added as changes are needed. If no equivalent for the granting of a DRP reservation is expected, DRP-IE may be removed after one or more SF (e.g., mMaxLostBeacons) and not before the possible MAS reservations have been relinquished or at least non-activated.

The DRP-IE may again appear after one or more SFs (e.g., mMaxLostBeacons), but before data transfer ends. For example, the presence of the DRP-IE means that a certain number of SFs, including the current one, of data are left. After connection ends, both DATA-IE and DRP-IE may be removed. Issuing a DRP-IE for indicating approaching end of data may create a large overhead concentrated in one SF, and therefore, this sub-method may be more appropriate for less bursty activities. It may be impossible to signal coming end of data for data bursts that are very short. The partial use of DRP-IE, in accordance with at least one embodiment of the present invention, actions taken at destination when reception of DRP-IE of corresponding device fails may only be taken if the DATA-IE is also not received. In other words, the presence of a DATA-IE shall be considered equivalent to the presence of a DRP-IE.

In at least one embodiment of the present invention, one or more bits in the DATA-IE may be dedicated to indicate activity of the link. In particular, bits may be assigned to represent a countdown counter of the remaining SF. For example, using one bit: “1” may indicate one or more SFs of data left and “0” may indicate the last SF of data; with two bits “11” may indicate three or more SF of data left, “10” may indicate that two SFs of data left, “01” may indicate that one SF of data left and “00” may indicate the last SF of data. Indicating that the end of data is approaching with DATA-IE may imply a constant overhead and less room for payload, but may be more appropriate when traffic is expected to be bursty. Alternatively to the count-down counter, one or more bits in the DATA-IE may be dedicated to a sequence counter (e.g., identifying the SF being sent). An additional optional field in accordance with at least one embodiment of the present invention may include one or more bits in the DATA-IE that are dedicated to indicating priority. The simplest case is one bit to indicate either regular or urgent data. With additional bits, a finer resolution is possible (e.g., IEEE802.1D may be mapped).

Generally, in cases other than where no acknowledgement is required, the presence of DATA-IE is also required at the destination device to carry ACK information. However, in case of No-ACK traffic, the DATA-IE may be removed if DRP-IE is present. In other words, if simultaneous use of DATA-IE and DRP-IE is employed (e.g., in the case of No-ACK traffic), the destination device may not include a DATA-IE in its beacon, but only keep its DRP-IE. In case of No-ACK traffic, the presence of the DATA-IE at the destination may not be required. In the case of No-ACK communication, the source may not be interested in feedback. Therefore, the DRP-IE may be removed at the destination side. The presence of the destination's beacon without any IE related to the data exchange between them may be enough for the source since mutual correct reception may be indicated by other means, like the correctness of BPOIE.

Various embodiments of the present invention may also support the virtual transmission of payload information. This method may result in data transmission with improved efficiency created by sending a “compressed” version of the data to be transmitted. Actual payload is still being sent using this method. However, the use of compression may help avoid some of the overhead associated with transmitting actual data. Transmission of “actual” data using virtual payload transmission may be done by skipping the translation step using look-up tables agreed upon by both the source and destination apparatuses at set-up. As opposed to the transmission of actual data in the payload: 1) all static information (i.e., information that does not change) such as data size, stream index, ACK mode and the destination address (depending on the addressing mode), etc. may be exchanged during set-up phase, and therefore, does not have to be repeated in each IE; and 2) only non-static information is transmitted in the data IE.

A source device configured to send compressed data may implement explicit addressing by appending a device address or other identification code to specify the intended destination of this specific traffic. In an alternative implementation, with implicit addressing the specification of the intended destination may occur before the data exchange when there may be negotiation between two or more devices on the creation of a control service link. When using implicit addressing, the enabled corresponding device (or devices) that receive this information is the intended destination of the control data information.

Corresponding apparatuses may include the information source and the related destinations. Destinations may include one or more apparatuses depending on the addressing scheme (unicast, broadcast and multicast). Explicit addressing may be required when a device needs to act as data source for more than one destination device at a time. Alternatively, separate set-ups with individual corresponding devices may be performed, and implicit addressing may be used. In other words, implicit addressing can be used when only one destination device is present for the given application, or in an instance including more source-destination pairs. In a situation including more source-destination pairs, the choice of codes and/or addresses should be done more carefully. An advantage is an even more compact data size. Using virtual payload transmission, a set-up phase may be performed prior to the actual data exchange. Since set-up may be performed once per session, the amount of information exchanged during set-up has little effect on the final efficiency of the entire communication session.

The set-up phase may be performed with or without the use of DP. The use of DP may be required in cases where the set-up information to be exchanged is too large to fit into the information element payload of one or a few beacons. With actual payload transmission as specified above, the DATA-IE shall include a length field in order to support variable data size. With virtual payload transmission, corresponding devices may agree at set-up on the DATA-IE length phase. (e.g., the DATA-IE size agreed upon during set-up may be selected depending on processing delay requirements implied by transcoding). DATA-IEs that are sent using virtual payload transmission are therefore of known length. This further improves overhead reduction.

To further reduce the size of the DATA-IE payload, a code may be associated with a corresponding “well-known” payload, to an action or more generally to any meaning of the carried information. A well-known payload may be, for example, any recurrent payload data.

The set-up information may be represented by a table. The codes may then correspond to addresses from the table that may be used at destination side to fetch the intended information, which may be represented by at least the device addresses (destination address) in case of explicit addressing, and the stream index may specify the information stream referred by the payload. Using this strategy of replacing well-known data, the payload can be as small as a few bits.

In a further example embodiment of the present invention, the payload may be coded into the address so that the table may include the actions for all possible destination devices participating in the set-up phase. In all virtual payload transmission methods, the code corresponding to a compressed version of the entire record may be exchanged. These codes may act like keywords for some information to be transmitted. Source and destination apparatuses may agree on a set of well known payload that they may exchange in the future. Actual payload samples may be exchanged at set-up time while building the table. Otherwise, these codes may be known before any communication takes place (e.g., hard-coded into devices). In practice, MAC 212 may receive information from upper layers regarding well-known payloads to be transferred. If not known in advance, the table may be built dynamically. After some processing/search at source side, the payload is coded into an address previously established with the destination. Instead of transferring the actual payload, the source device sends the code. The destination may then interpret the actual payload from the table and send it to upper layer. This exchange of codes/addresses may represent the virtual exchange of payload between source and destination. Virtual payload transmission may be comparable to source coding, but is done in MAC 212.

The payload exchanged during the set-up phase may be a string of data, possibly recurring with some frequency in transmissions. This string may be also secured in the sense it has been exchanged using secure transmission (e.g., encrypted transmission). However, substantial overhead is not added since security is established only at set-up. As a result, only sending the address does not reveal any information that may be used by possible eavesdroppers. In at least one embodiment of the present invention, set-up information may be retained for use in upcoming sessions between devices that would agree to use the existing set-up information.

In an alternative configuration example, set-up information may be coded in hardware or firmware. In this scenario, corresponding devices may simply exchange the coded information. In case of multicast or broadcast communication, newcomers to those groups may require repetition of the set-up phase. Further, set-up information for virtual payload may be memorized and reused afterwards, including identification for the particular set-up settings. This configuration may be beneficial since a setup-ID may be much smaller than an entire setup table.

Another example embodiment may include remote configuration of appliances during the set-up phase. For example, features in a controlled device may be changed from the control device, possibly being gathered from another source. Depending on implementation, acknowledgement (ACK) may also be included. The acknowledgement type related to explicit addressing may be defined by the specific implementation or embodiment. The reason for redefining the ACK with virtual payload transmission is that every octet saved then becomes available for data. For example, in WiMedia MAC, No-ACK, immediate ACK (Imm-ACK), and block ACK (B-ACK) are the available options. The ACK frames that are used with virtual payload transmission may be redefined. The possible acknowledgement type, and its format, may be agreed during the set-up phase. For instance, with reference to the example of WiMedia MAC 212, the destination address field in Imm-ACK and B-ACK is not needed if implicit addressing is agreed in the set-up phase. The Frame Counter (one octet) may be agreed upon in the set-up phase, and therefore, may be not needed. If fixed data size is agreed upon in set-up, buffer size (two octets) may be replaced by a shorter counter and the reserved field is unneeded.

Acknowledgement IEs may be specified as two basic types: short and long. With short ACK, the entire received control data payload (CDP) IE may be acknowledged by properly setting a specific IE field. With long ACK, each received field of the CDP-IE is acknowledged. This may be done by simply replicating their contents. A device may start the set-up of a control link with one or more neighboring apparatuses. This may be done by using a control link set-up (CLS) IE (e.g., control service link set-up for implicit addressing). The initiating device may specify and set the addresses of the source and destination devices, respectively. Alternatively, the last field may be replaced by a replica of the destination field. Depending on the particular implementation, the devices may agree upon and set a vector of link parameters. The parameters may include ACK type. Link set-up may be acknowledged using, for example, the long version in which the field contents are replicated, or the short version, in which the entire set-up proposal is acknowledged.

In some instances, it may make sense to send data in both the BP and DP at substantially the same time, for example, to help processing for stream synchronization at a destination device. In an alternate configuration, an apparatus may act as a gateway between data-in-beacon and data in DP. This may enable communication between legacy devices acknowledging the conveyance of data only at the data plane, and newer devices possibly supporting only control plane data conveyance and not implementing any DP functionality. Only data forwarding done at the control plane (e.g., via beacon signals) may be managed directly. For example, one data hop may be done using a data-in-beacon method and the other data hop may be executed using regular/legacy DP methods.

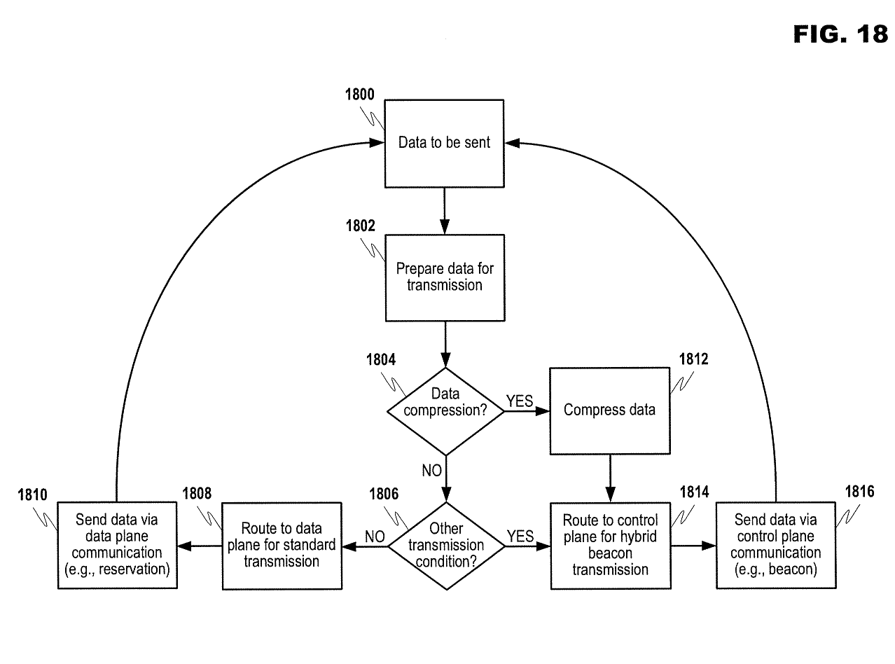

Now referring to FIG. 18, a flowchart describing an example process in accordance with at least one embodiment of the present invention is now disclosed. Step 1800 may began the process with the realization of data to be sent from an apparatus. This data may originate, from an application executing on the device. The data may then be prepared for transmission in step 1802. This may include the routing of the data through system level resources, formatting, packetization, etc. In step 1804 the data queued for transmission may be evaluated to determine if the data has a corresponding “compressed” form. Payload data may have a corresponding compressed form if, for example, it may be considered information that is already known amongst the participating apparatuses (e.g., it is data that is hard or soft-coded in the devices, is implemented as part of the particular protocol being used, etc.) it is a command, message that is frequently sent, a compressed form was established in a table created as a part of the connection establishment, etc.

If no compressed version exists (e.g., for use in virtual payload transmission), then in step 1806 a determination may be made as to whether a transmission condition exists that makes it appropriate to transmit the data from the data plane. This determination may include, for example, determining if the data can be sent entirely in one data-IE payload, or if the data must be divided between multiple payloads, whether the overall quality of service will be negatively impacted by dividing the data between two or more packets. The process of step 1806 may also include determining whether encoding and/or decoding information was previously exchanged agreed upon between devices, or if encoding and/or decoding information is included in the current communication proceeding between the participating apparatuses.

Alternatively, if a corresponding compressed version of the data to be sent exists in step 1804, then in step 1812, the data may be “compressed.” This process may include the replacement of the actual data to be sent with corresponding abbreviated data in preparation for virtual payload transmission. Step 1812 and 1806 (if the data meets at least one predetermined transmission condition) may then proceed to step 1814 where data is routed to the control plane for transmission. The data may then be sent from the control plane in step 1816, for example, as payload data in a beacon signal. The process may then return to step 1800 to await further data.

Accordingly, it will be apparent to persons skilled in the relevant art that various changes in forma and detail can be made therein without departing from the spirit and scope of the invention. The breadth and scope of the present invention should not be limited by any of the above-described example embodiments, but should be defined only in accordance with the following claims and their equivalents.

1. A method, comprising:
determining whether at least a portion of data to be transmitted corresponds to at least one transmission condition;
if the at least a portion of data corresponds to at least one transmission condition, transmitting the at least a portion of data in a beacon signal packet in a wireless transport; and
transmitting the at least a portion of data using data plane resources in the wireless transport if the at least a portion of data does not correspond to at least one transmission condition.

2. The method of claim 1, wherein the at least one transmission condition includes determining whether the at least a portion of data to be transmitted comprises at least one of destination address information or stream index information.

3. The method of claim 1, wherein the at least one transmission condition includes determining whether at least one of destination address information or stream index information were previously agreed upon during wireless connection establishment.

4. The method of claim 1, wherein the at least one transmission condition includes determining whether at least one of data encoding or decoding information was previously agreed upon, or is included in current wireless data communication.

5. The method of claim 1, wherein the at least a portion of data is transmitted within an information element in the beacon signal packet.

6. The method of claim 5, wherein the at least one transmission condition includes determining whether the at least a portion of data can be transmitted in the payload of the information element in the beacon signal packet.

7. The method of claim 1, wherein the at least one transmission condition includes determining whether the at least a portion of data can be transmitted in the payload of two or more beacon signal packets without impacting overall quality of service for the wireless transport.

8. The method of claim 5, wherein the information element in the beacon signal packet comprises at least one of destination address information or stream index information.

9. A computer program product comprising a computer executable program code embodied on a computer readable medium, comprising:
a computer readable program code configured to determine whether at least a portion of data to be transmitted corresponds to at least one transmission condition;
a computer readable program code configured to transmit the at least a portion of data in a beacon signal packet in a wireless transport if the at least a portion of data corresponds to at least one transmission condition; and
a computer readable program code configured to transmit the at least a portion of data using data level resources in the wireless transport if the at least a portion of data does not correspond to at least one transmission condition.

10. The computer program product of claim 9, wherein the at least one transmission condition includes determining whether the at least a portion of data to be transmitted comprises at least one of destination address information or stream index information.

11. The computer program product of claim 9, wherein the at least one transmission condition includes determining whether at least one of destination address information or stream index information were previously agreed upon during wireless connection establishment.

12. The computer program product of claim 9, wherein the at least one transmission condition includes determining whether at least one of data encoding or decoding information was previously agreed upon, or is included in current wireless data communication.

13. The computer program product of claim 9, wherein the at least a portion of data is transmitted within an information element in the beacon signal packet.

14. The computer program product of claim 13, wherein the at least one transmission condition includes determining whether the at least a portion of data can be transmitted in the payload of the information element in the beacon signal packet.

15. The computer program product of claim 9, wherein the at least one transmission condition includes determining whether the at least a portion of data can be transmitted in the payload of two or more beacon signal packets without impacting overall quality of service for the wireless transport.

16. The computer program product of claim 13, wherein the information element in the beacon signal packet comprises at least one of destination address information or stream index information.

17. An apparatus, comprising:
at least one communication module configured to communicate using one or more wireless transports; and
a processor, the processor being further configured to:
determine whether at least a portion of data to be transmitted corresponds to at least one transmission condition;
transmit the at least a portion of data in a beacon signal packet in a wireless transport if the at least a portion of data corresponds to at least one transmission condition; and
transmit the at least a portion of data using data level resources in the wireless transport if the at least a portion of data does not correspond to at least one transmission condition.

18. The apparatus of claim 17, wherein the at least one transmission condition includes determining whether the at least a portion of data to be transmitted comprises at least one of destination address information or stream index information.

19. The apparatus of claim 17, wherein the at least one transmission condition includes determining whether at least one of destination address information or stream index information were previously agreed upon during wireless connection establishment.

20. The apparatus of claim 17, wherein the at least one transmission condition includes determining whether at least one of data encoding or decoding information was previously agreed upon, or is included in current wireless data communication.

21. The apparatus of claim 17, wherein the at least a portion of data is transmitted within an information element in the beacon signal packet.

22. The apparatus of claim 21, wherein the at least one transmission condition includes determining whether the at least a portion of data can be transmitted in the payload of the information element in the beacon signal packet.

23. The apparatus of claim 17, wherein the at least one transmission condition includes determining whether the at least a portion of data can be transmitted in the payload of two or more beacon signal packets without impacting overall quality of service for the wireless transport.

24. The apparatus of claim 21, wherein the information element in the beacon signal packet comprises at least one of destination address information or stream index information.

25. An apparatus, comprising:
means for determining whether at least a portion of data to be transmitted corresponds to at least one transmission condition;
means for transmitting the at least a portion of data in a beacon signal packet in a wireless transport, if the at least a portion of data corresponds to at least one transmission condition; and
means for transmitting the at least a portion of data using data plane resources in the wireless transport if the at least a portion of data does not correspond to at least one transmission condition.

26. A system, comprising:
a source apparatus; and
at least one destination apparatus;
the source apparatus determining whether at least a portion of data to be transmitted corresponds to at least one transmission condition;
if the at least a portion of data corresponds to at least one transmission condition, the source apparatus further transmitting to the at least one apparatus, the at least a portion of data in a beacon signal packet in a wireless transport, and transmitting the at least a portion of data using data plane resources in the wireless transport if the at least a portion of data does not correspond to at least one transmission condition.

27. The method of claim 1, wherein said transmitting the at least a portion of data in a beacon signal packet includes transmitting a stream or logical flow of information that is delivered as a unit between from one device to one or more other devices.

28. The method of claim 27, wherein said transmitting the at least a portion of data in a beacon signal packet further includes transmitting a stream index/delivery ID to enable transmission of payload data in a payload data field in the beacon signal packet.

29. The computer program product of claim 9, wherein said transmitting the at least a portion of data in a beacon signal packet includes transmitting a stream or logical flow of information that is delivered as a unit between from one device to one or more other devices.

30. The computer program product of claim 29, wherein said transmitting the at least a portion of data in a beacon signal packet further includes transmitting a stream index/delivery ID to enable transmission of payload data in a payload data field in the beacon signal packet.

31. The apparatus of claim 17, wherein said transmitting the at least a portion of data in a beacon signal packet includes transmitting a stream or logical flow of information that is delivered as a unit between from one device to one or more other devices.

32. The apparatus of claim 31, wherein said transmitting the at least a portion of data in a beacon signal packet further includes transmitting a stream index/delivery ID to enable transmission of payload data in a payload data field in the beacon signal packet.

33. A method, comprising:
receiving an information element in a beacon signal packet in a wireless transport;
interpreting said information element as indicating that there is payload data related to an existing stream in the beacon signal packet; and
utilizing the payload data in the beacon signal packet.

34. The method of claim 33, wherein said beacon signal packet includes a stream or logical flow of information that is delivered as a unit between from one device to one or more other devices.

35. The method of claim 34, wherein said beacon signal packet further includes a stream index/delivery ID to enable transmission of payload data in a payload data field in the beacon signal packet.

36. A computer program product comprising a computer executable program code embodied on a computer readable medium, comprising:
a computer readable program code configured to receive an information element in a beacon signal packet in a wireless transport;
a computer readable program code configured to interpret said information element as indicating that there is payload data related to an existing stream in the beacon signal packet; and
a computer readable program code configured to utilize the payload data in the beacon signal packet.

37. The computer program product of claim 36, wherein said beacon signal packet includes a stream or logical flow of information that is delivered as a unit between from one device to one or more other devices.

38. The method of claim 37, wherein said beacon signal packet further includes a stream index/delivery ID to enable transmission of payload data in a payload data field in the beacon signal packet.

39. An apparatus, comprising:
a receiver configured to receive an information element in a beacon signal packet in a wireless transport;
a processor configured to interpret said information element as indicating that there is payload data related to an existing stream in the beacon signal packet; and
said processor utilizing the payload data in the beacon signal packet.

40. The apparatus of claim 39, wherein said beacon signal packet includes a stream or logical flow of information that is delivered as a unit between from one device to one or more other devices.

41. The apparatus of claim 40, wherein said beacon signal packet further includes a stream index/delivery ID to enable transmission of payload data in a payload data field in the beacon signal packet.
